(19) United States
(12) Patent Application Publication
(10) Pub. No.: US 2013/0330601 A1
(43) Pub. Date: Dec. 12, 2013

(54) COIN BATTERY

(71) Applicants: Touta Mizuta, Osaka (JP); Tsuyoshi Yanagimoto, Osaka (JP); Shinji Fujii, Osaka (JP); Yukihiro Gotanda, Osaka (JP); Toshihiko Ikehata, Osaka (JP)

(72) Inventors: Touta Mizuta, Osaka (JP); Tsuyoshi Yanagimoto, Osaka (JP); Shinji Fujii, Osaka (JP); Yukihiro Gotanda, Osaka (JP); Toshihiko Ikehata, Osaka (JP)

(73) Assignee: PANASONIC CORPORATION, Osaka (JP)

(21) Appl. No.: 14/001,264

(22) PCT Filed: Mar. 23, 2012
(86) PCT No.: PCT/JP2012/002046

§ 371 Date: Aug. 23, 2013

(30) Foreign Application Priority Data
Mar. 25, 2011 (JP) 2011-067247

(51) Int. Cl. H01M 2/02

(52) U.S. Cl. CPC H01M 2/0222
USPC 429/174

(57) ABSTRACT

Disclosed is a coin battery including: a cylindrical battery can having a bottom portion, and a first side wall rising from the periphery of the bottom portion; a sealing plate having a top portion, and a second side wall extending from the periphery of the top portion along the inner side of the first side wall; a gasket interposed and compressed between the first side wall and the second side wall; and a power generation element sealed with the battery can and the sealing plate. In order to improve the battery capacity while ensuring leakage resistance, the second side wall is provided with a bulging portion bulging outward, and a part of the power generation element is disposed inside the bulging portion. The negative electrode is preferably in contact with the inner side of the bulging portion.

### TECHNICAL FIELD

The present invention relates to coin batteries, and specifically relates to coin batteries that ensure leakage resistance in high temperature atmosphere and have improved battery capacity.

### BACKGROUND ART

Coin batteries including a flat cylindrical housing and a power generation element encased together with non-aqueous electrolyte in the housing are often called button batteries or flat batteries. Coin batteries are small in size and thickness, and because of this feature, are widely used for watches, keyless entry and other applications that require miniature power sources, or used as memory backup for office automation (OA) devices or factory automation (FA) devices and other applications that requires power sources with long operating life. Moreover, coin batteries are used as power sources for various meters or measuring devices, and the range of application thereof is expanding. The operating environment of coin batteries is also expanding from low temperature or room temperature environment to high temperature environment.

A typical coin battery is formed by placing a positive electrode and a negative electrode face to face, with a separator interposed therebetween in a battery can, injecting electrolyte into the battery can, and closing the opening of the battery can with a sealing plate, followed by crimping the opening end onto the sealing plate, with a gasket interposed therebetween. In a coin battery with this structure, electrolyte leakage may occur when it is used continuously in high temperature atmosphere or subjected to extreme temperature impact.

Specifically, if the electrolyte swells or vaporizes at high temperatures, the internal pressure of the battery increases to cause the sealing plate and the battery can to bulge outward. At this time, the hermeticity between the battery can and the gasket or between the sealing plate and the gasket is reduced. Therefore, if the sealing portion is deformed, leakage is likely to occur.

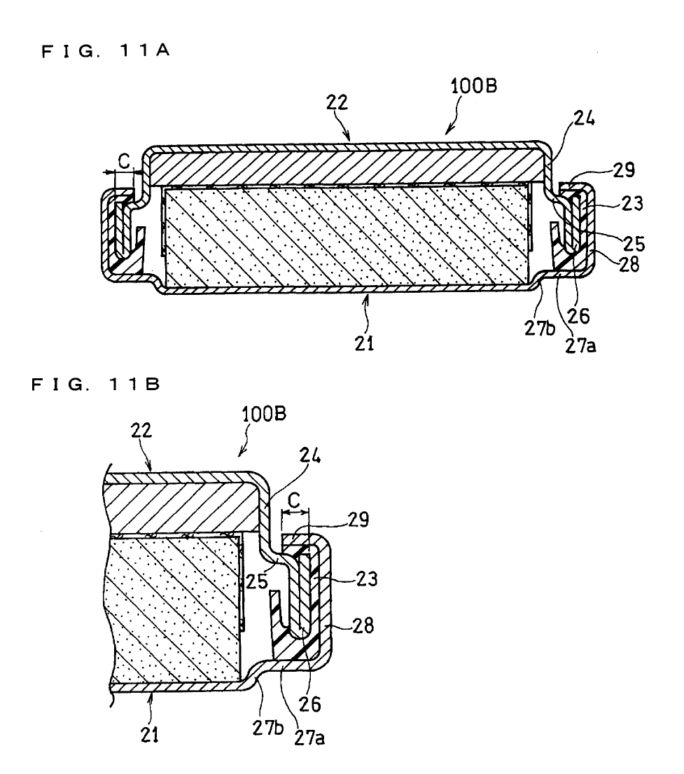

In order to prevent leakage, one proposal suggests a battery 100A, as illustrated in FIG. 10A, including a sealing plate 22, a battery can 21, and a gasket 23. The sealing plate 22 has a flange portion 25 provided at its periphery, and an extending portion 26 extending vertically below from the flange portion 25 so as to face a side wall 28 of the battery can 21. The battery can 21 has a step portion 27b provided at the periphery of its base and having an outer diameter smaller than the inner diameter of the extending portion 26. The gasket 23 is disposed over the region from an annular portion 27a outside the step portion 27b to the edge of the side wall 28 of the battery can 21. FIG. 10B is an enlarged view of an essential part of the battery 100A. Highly reliable sealing is enabled by crimping the end portion of the side wall 28 onto the flange portion 25 so as to compress the battery gasket 23 (see Patent Literature 1). According to this configuration, leakage resistance can be ensured even in high temperature (furthermore, high humidity) atmosphere or under extreme temperature impact.

### CITATION LIST

### Patent Literature

[PTL 1] International Publication No. WO2002/013290

### SUMMARY OF INVENTION

### Technical Problem

There is, however, a strong demand for further miniaturization of coin batteries, which necessitates modifications to the batter shape in order to compensate the reduction in internal volume of the housing associated with miniaturization. One possible modification is, as illustrated in FIG. 11A, to reduce the width of the flange portion 25 of the sealing plate 22 without changing the diameter of a battery 100B. This can increase the diameter of the top portion of the sealing plate 22 by an amount corresponding to the reduced width of the flange portion 25, and thus can increase the volume inside the sealing plate 22. FIG. 11B is an enlarged view of an essential part of the battery 100B.

Reducing the width of the flange portion 25, however, makes the width C of an end portion (a crimp portion 29) of the side wall 28 of the battery can 21, i.e., the portion to be crimped onto the flange portion 25, smaller than the width of the battery 100A illustrated in FIGS. 10A and 10B. As a result, the compressed area of the gasket 23 is reduced, and sufficient hermeticity may not be maintained. Eventually, it becomes difficult to ensure leakage resistance.

In view of the above, the present invention intends to provide a coin battery that ensures leakage resistance even in high temperature atmosphere or under extreme temperature impact, and has improved battery capacity.

### Solution to Problem

The present invention relates to a coin battery including: a cylindrical battery can having a bottom portion, and a first side wall rising from the periphery of the bottom portion; a sealing plate having a top portion, and a second side wall extending from the periphery of the top portion along the inner side of the first side wall; a gasket interposed and compressed between the first side wall and the second side wall; and a power generation element sealed with the battery can and the sealing plate.

The second side wall has a bulging portion bulging outward, and a part of the power generation element is disposed inside the bulging portion.

### Advantageous Effects of Invention

According to the present invention, the battery capacity of coin batteries can be improved than before, while the leakage resistance thereof is ensured.

While the novel features of the invention are set forth particularly in the appended claims, the invention, both as to organization and content, will be better understood and appreciated, along with other objects and features thereof, from the following detailed description taken in conjunction with the drawings.

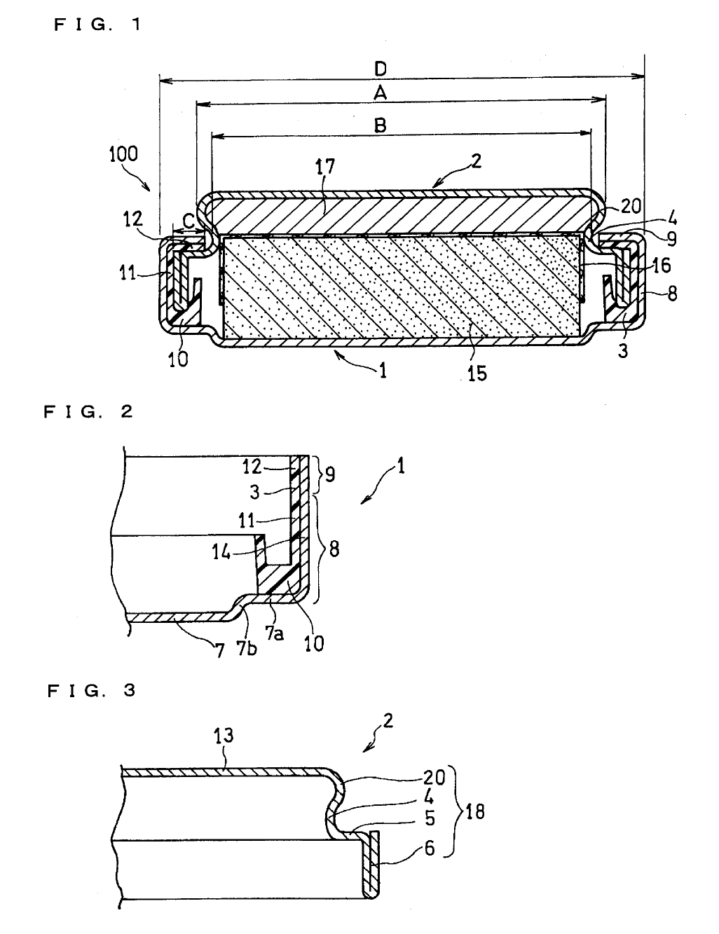

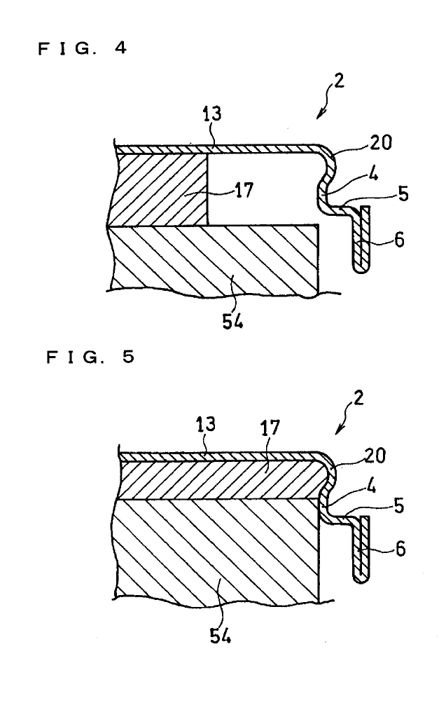

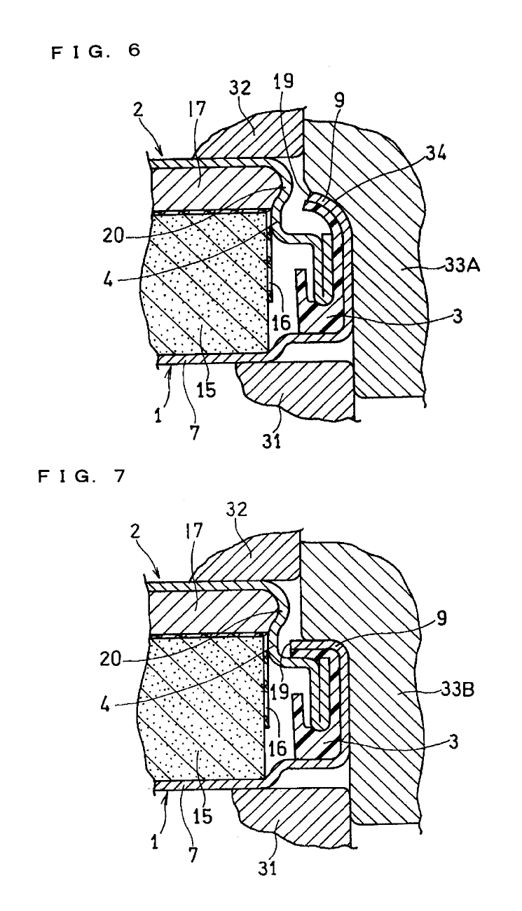

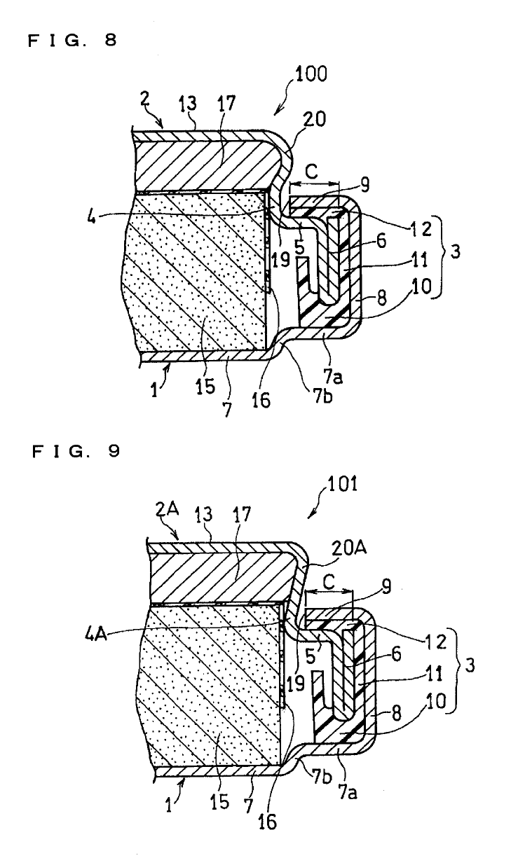

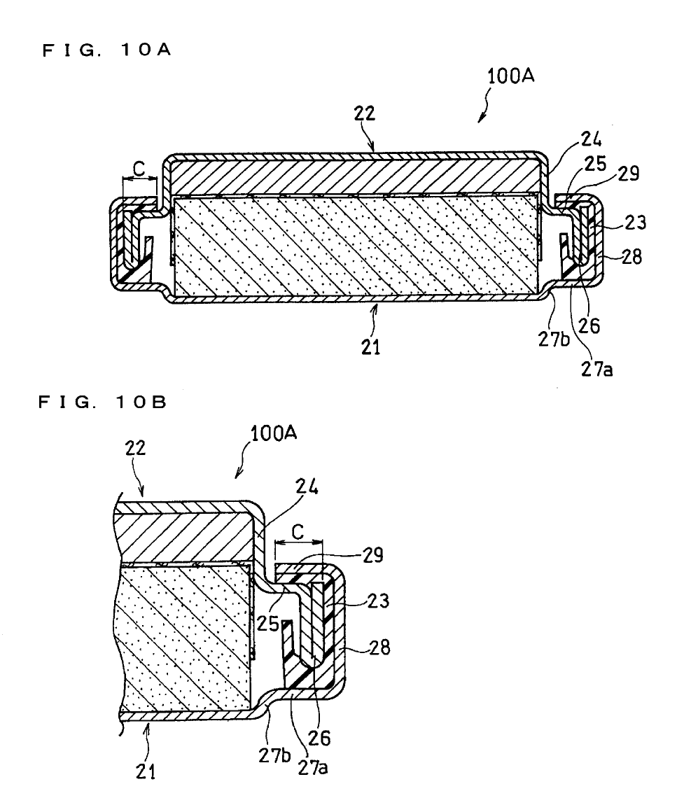

### BRIEF DESCRIPTION OF DRAWINGS

[FIG. 1] A longitudinal cross-sectional view illustrating a configuration of a coin battery according to one embodiment of the present invention

[FIG. 2] A partial cross-sectional view of a battery can and a gasket included in the coin battery according to one embodiment of the present invention

[FIG. 3] A partial cross-sectional view of a sealing plate included in the coin battery according to one embodiment of present invention

[FIG. 4] A partial cross-sectional view of the negative electrode during the process of press-fitting onto the inner side of the sealing plate

[FIG. 5] A partial cross-sectional view of the negative electrode at the end of the process of press-fitting onto the inner side of the sealing plate

[FIG. 6] A partial cross-sectional view of the coin battery and dies during the process of crimping an end portion of the side wall of the battery can onto a flange portion of the sealing plate

[FIG. 7] A partial cross-sectional view of the coin battery and dies at the end of the process of crimping an end portion of the side wall of the battery can onto a flange portion of the sealing plate

[FIG. 8] An enlarged partial cross-sectional view of an essential part of the coin battery according to one embodiment of the present invention

[FIG. 9] An enlarged partial cross-sectional view of an essential part of a coin battery according to another embodiment of the present invention

[FIG. 10A] A longitudinal cross-sectional view illustrating a configuration of a conventional coin battery

[FIG. 10B] An enlarged partial cross-sectional view of an essential part of the coin battery of FIG. 10A

[FIG. 11A] A longitudinal cross-sectional view illustrating a configuration of a conventional coin battery in which the volume inside the sealing plate is increased

[FIG. 11B] An enlarged partial cross-sectional view of an essential part of the coin battery of FIG. 11A

### DESCRIPTION OF EMBODIMENT

One aspect of the present invention includes: a cylindrical battery can having a bottom portion, and a first side wall rising from the periphery thereof; a sealing plate having a top portion, and a second side wall extending from the periphery of the top portion along the inner side of the first side wall; a gasket interposed and compressed between the first side wall and the second side wall; and a power generation element sealed with the battery can and the sealing plate. The second side wall has a bulging portion bulging outward (outward in the diameter direction of a coin battery), and a part of the power generation element is disposed inside the bulging portion. The height of the first side wall is smaller than the diameter of the bottom portion, and the battery can is shallow in depth.

According to the above configuration, since the sealing plate is provided with the bulging portion, the volume inside the sealing plate can be increased. Since a part of the power generation element is disposed inside the bulging portion, a higher capacity of the coin battery can be achieved. In addition, since the gasket interposed between the first side wall of the battery can and the second side wall of the sealing plate is compressed over a wide area, the hermeticity between the battery can and the gasket or between the sealing plate and the gasket is unlikely to be reduced even when the internal pressure of the battery is increased in high temperature and high humidity atmosphere, or under extreme temperature impact.

The power generation element includes, for example, a positive electrode, a negative electrode that includes lithium metal or lithium alloy and faces the positive electrode with a separator interposed therebetween, and a non-aqueous electrolyte. In this case, the coin battery is a non-aqueous electrolyte battery (e.g., a lithium ion battery). The negative electrode including lithium metal or lithium alloy has malleability which is characteristic of metal materials, and therefore, can be comparatively easily packed inside the bulging portion by pressure application. Therefore, the negative electrode can be packed inside the sealing plate until the negative electrode comes in contact with the inner side of the bulging portion, which allows for easy achievement of a higher capacity.

The second side wall of the sealing plate preferably has a constricted portion continuing from the bulging portion, a flange portion extending outward (outward in the diameter direction of the coin battery) from the constricted portion, and an extending portion extending from the flange portion so as to face the first side wall of the battery can. In the case where the second side wall has a bulging portion and a constricted portion, the width of the flange portion can be set comparatively large. This allows the end portion of the first side wall of the battery can to be crimped onto the comparatively wide flange portion. Therefore, the gasket interposed between the flange portion and the end portion of the first side wall can be compressed over a wide area.

In view of effectively achieving a higher capacity, it suffices if a maximum outer diameter A of the bulging portion is equal to or less than an outer diameter D of the battery (i.e., the maximum outer diameter of the first side wall of the battery can). However, for ease of crimping the end portion of the first side wall of the battery can onto the flange portion of the sealing plate, the maximum outer diameter A of the bulging portion, a minimum outer diameter B of the constricted portion, and the outer diameter D of the battery preferably satisfy 0<(A−B)/2, and 0.7<(D−A)/2, and more preferably satisfy 0.1 mm (A−B)/2. Here, the value of (A−B)/2 corresponds to the length of the bulging portion in the diameter direction of the coin battery, and can be used as an index of a higher capacity. The higher the value of (A−B)/2 is, the larger the width of the flange portion of the sealing plate and the volume inside the sealing plate tend to be.

Next, a coin battery according to one embodiment of the present invention is described with reference to the appended drawings. It is to be noted, however, that the embodiment below is a mere concrete example of the invention and does not limit the technical scope of the invention in any way.

In a coin battery 100 illustrated in FIG. 1, a pellet-shaped positive electrode 15 is disposed inside a shallow bottomed-cylindrical battery can 1. Likewise, inside a shallow bottomed-cylindrical sealing plate 2, a negative electrode 17 is disposed so as to face the positive electrode 15, with a separator 16 interposed therebetween. The battery can 1, the sealing plate 2, and a gasket 3 interposed between the side walls of the battery can 1 and the sealing plate 2 form a housing of the coin battery 100, and in the housing, the positive and negative electrodes 15 and 17 serving as components of the power generation element are enclosed together with an electrolyte (not shown).

FIG. 2 illustrates a cross-sectional structure of the battery can 1 and the gasket 3 before being fabricated into a coin battery. The battery can 1 has a bottom portion 7, and a first side wall 14 rising vertically above from the periphery of the bottom portion 7. The bottom portion 7 is provided, at its periphery, with an inclined portion 7b that is inclined upward slightly, and an annular portion 7a that continues from the inclined portion 7b to where the first side wall 14 rises. A base portion 10 of the gasket 3 is in contact with the annular portion 7a.

FIG. 3 illustrates a cross-sectional structure of the sealing plate 2 before being fabricated into a coin battery. The sealing plate 2 has a top portion 13 and a second side wall 18 that extends from the periphery of the top portion 13 along the inner side of the first side wall 14 of the battery can 1. The second side wall 18 has a bulging portion 20 that bulges outward, a constricted portion 4 continuing from the bulging portion 20, a flange portion 5 extending substantially horizontally outward from the constricted portion 4, and an extending portion 6 extending substantially vertically below from the flange portion 5 so as to face the first side wall 14 of the battery can 1. The larger the maximum outer diameter of the bulging portion 20 is, the more preferable for achieving a higher capacity.

In FIG. 3, the extending portion 6 is folded such that its extreme end is flush with the surface of the flange portion 5. It is not necessary, however, for the extending portion 6 to have such a folded structure. When the extending portion 6 has a folded structure, the strength of the sealing portion improves, and the gasket 3 can be easily compressed at a higher rate in the below-mentioned crimping process.

Over the region from the annular portion 7a of the bottom portion 7 to the opening end of the first side wall 14 of the battery can 1, the gasket 3 is disposed so as to fit with the second side wall 18 of the sealing plate 2. Therefor, by bending inward the opening end of the first side wall 14 of the battery can 1 and crimping it onto the flange portion 5 of the sealing plate 2, the gasket 3 can be firmly compressed at least between the opening end of the first side wall 14 of the battery can 1 and the flange portion 5 of the sealing plate 2. In other words, the opening end of the first side wall 14 serves as a crimp portion 9 extending horizontally inward from a rising portion 8.

The gasket 3 has: a base portion 10 to be interposed between the lower end of the extending portion 6 of the sealing plate 2 and the annular portion 7a of the battery can 1; a side portion 11 to be interposed between the extending portion 6 of the sealing plate 2 and the rising portion 8 of the battery can 1; and a shoulder portion 12 to be interposed between the flange portion 5 of the sealing plate 2 and the crimp portion 9 of the first side wall 14 of the battery can 1.

Next, a method for producing a coin battery is described.

First, as illustrated in FIG. 4, the negative electrode 17 is disposed inside the top portion 13 of the sealing plate 2. Then, the negative electrode 17 is pressed with a pressing die 54 from inside the sealing plate 2. In pressing, as illustrated in FIG. 5, the negative electrode 17 is pressed such that the negative electrode 17 is packed in at least part of the interior of the bulging portion 20.

On the other hand, in the battery can 1, the positive electrode 15 and the separator 16 are disposed, and an electrolyte is injected. Then, the ring-shaped gasket 3 is disposed along the inner side from the annular portion 7a of the bottom portion 7 to the rising portion 8 of the battery can 1. Subsequently, the opening of the battery can 1 is closed with the sealing plate 2 in which the negative electrode 17 is packed, and then, crimping is performed in the following manner as illustrated in FIGS. 6 and 7.

In a preparatory sealing process, crimping is first performed by using: a columnar lower die 31 with a diameter D1 for pressing the bottom portion 7 of the battery can 1 from outside; a columnar upper die 32 with a diameter D2 smaller than the diameter D1, for pressing the top portion 13 of the sealing plate 2 from outside; and a tubular sealing die 33A having a first opening to which the lower die 31 is to be fittingly inserted, and a second opening to which the upper die 32 is to be fittingly inserted. The sealing die 33A is hollow, with the first and second openings being coaxial with each other. The inner diameter of the first opening corresponds to the diameter D1, and the inner diameter of the second opening corresponds to the diameter D2. The diameter of the hollow from the first opening to around halfway between the first and second openings corresponds to the diameter D1, and the diameter of the hollow from around halfway to the second opening corresponds to the diameter D2. The cross section of a region of the hollow where the diameter changes from D1 to D2 (a rounded (R) portion 34) is curved like an arc as illustrated in FIG. 6.

The battery can 1 whose opening is closed with the sealing plate 2 is inserted into the hollow of the sealing die 33A through the second opening. While the bottom portion 7 of the battery can 1 is pressed from outside with the lower die 31, and the top portion 13 of the sealing plate 2 is pressed from outside with the upper die 32, the sealing die 33A is descended in the direction directed from the sealing plate 2 to the battery can 1, so that the opening end (crimp portion 9) of the first side wall 14 of the battery can 1 is bent inward along the R portion 34 of the sealing die 33A.

In a main sealing process, the sealing die 33A is replaced with a sealing die 33B in which the R portion 34 has a smaller radius of curvature than that of the sealing die 33A and has a substantially right-angle cross section. Pressure is then applied to the battery can 1 within the sealing die 33B, so that the crimp portion 9 of the first side wall 14 of the battery can 1 is crimped onto the flange portion 5 of the sealing plate 2 as illustrated in FIG. 7. The bulging length of the bulging portion 20 and the length of the crimp portion 9 are each set such that an extreme end 19 of the crimp portion 9 will not come in contact with the bulging portion 20. The gasket 3 is disposed over the region reaching the extreme end 19 of the crimp portion 9 so that the extreme end 19 of the crimp portion 9 will not come in contact with the sealing plate 2.

When the crimp portion 9 is crimped onto the flange portion 5 of the sealing plate 2, the base portion 10 of the gasket 3 is also compressed between the annular portion 7a of the bottom portion 7 of the battery can 1 and the lower end of the extending portion 6 of the second side wall 18 of the sealing plate 2. Simultaneously, the side portion 11 of the gasket 3 is compressed between the rising portion 8 of the battery can 1 and the extending portion 6 of the sealing plate 2, and the shoulder portion 12 of the gasket 3 is compressed between the crimp portion 9 of the battery can 1 and the flange portion 5 of the sealing plate 2. Due to the presence of the bulging portion 20 and the constricted portion 4 in the sealing portion 2, the length C of the crimp portion 9 can be sufficiently long, and the shoulder portion 12 can be compressed over a sufficiently wide area. As a result, high hermeticity can be obtained.

The larger the size of the coin battery is, the higher the stress caused by thermal impact is. It is therefore preferable to set the length C of the crimp portion 9 according to the size of the coin battery. Specifically, the relationship between the length C of the crimp portion 9 and the outer diameter D of the coin battery preferably satisfies 0.06 2C/D≦0.15.

Releasing the lower die 31, the upper die 32 and the sealing die 33B provides a coin battery having a structure as illustrated in FIG. 8. FIG. 8 is an enlarged cross-sectional view of an essential part of the coin battery of FIG. 1.

The shapes of the battery can and the sealing plate are not limited to those as mentioned above. For example, the coin battery of the present invention may have a shape as illustrated in FIG. 9. A battery 101 of FIG. 9 has the same structure as that of the battery 100 of FIG. 8, except that a sealing plate 2A having a different shape is used. The sealing plate 2A has a bulging portion 20A and a constricted portion 4A, the shapes of which are different from those mentioned above. The bulging portion 20A is slanted upward from the innermost end of the flange portion 5.

The coin battery of the present invention is described below more specifically by way of Examples, but the present invention is not to be construed as being limited to the following Examples.

### Example 1

A coin battery as illustrated in FIG. 1 was produced in the following manner. The produced coin battery had an outer diameter D of 20 mm and a thickness of 5 mm.

### (i) Positive Electrode

To 100 parts by mass of manganese dioxide serving as a positive electrode active material, 4 parts by mass of carbon black serving as an electrical conductive material, and 5 parts by mass of tetrafluoroethylene-hexafluoropropylene copolymer serving as a binder were added, and mixed together, to prepare a positive electrode material mixture. The positive electrode material mixture was molded into a disc-like pellet having a diameter of 13.5 mm, to give a positive electrode 15.

### (ii) Negative Electrode

A metal lithium foil having a thickness before pressing of 0.9 mm was punched in a size of 16 mm in diameter, to give a negative electrode 17.

(iii) Separator

A polypropylene nonwoven fabric was used as a separator 16.

### (iv) Electrolyte

In a mixed solvent of 8:2 (volume ratio) propylene carbonate and dimethyl ether, lithium perchlorate was dissolved as a solute at a concentration of 1 mol/L, to prepare a non-aqueous electrolyte.

### (iv) Battery Can

A 250-μm-thick stainless steel sheet (SUS444) was used to form a battery can 1 as illustrated in FIG. 2 in which the inner diameter of the first side wall 14 was 19 mm. The diameter of the bottom portion 7 as measured at the center of the inclined portion 7b was set to 16 mm, and the width of the annular portion 7a was set to 1.5 mm. The length of the first side wall 14 was set such that the length of the crimp portion 9 became 1 mm.

### (v) Sealing Plate

A 250-μm-thick stainless steel sheet (SUS304) was used to form a sealing plate 2 as illustrated in FIG. 3 in which the outer diameter of the extending portion 6 with folded structure was 19 mm. The maximum diameter A of the bulging portion 20 was set to 18 mm, and the minimum diameter B of the constricted portion was set to 17 mm. In short, (A−B)/2 was set to 0.5 mm. (D−A)/2 was 1 mm.

### (vi) Gasket

A polypropylene gasket as illustrated in FIG. 2 in which the thickness of the base portion 10 was 1 mm and the thickness of the side portion was 0.5 mm was prepared.

(vii) Fabrication of Battery

The negative electrode 17 was attached on the inner side of the sealing plate 2, and pressed, as illustrated in FIG. 5, with a pressing die toward the top portion 13 of the sealing plate 2 until the negative electrode 17 contacts the inner side of the bulging portion 20. On the other hand, the positive electrode 15 was placed on the inner side of the battery can 1, then the separator 16 was placed on the positive electrode 15, and the electrolyte was injected. Subsequently, a sealant composed of blown asphalt and mineral oil was applied onto the extending portion 6 of the sealing plate 2. The opening of the battery can 1 was closed with the sealing plate 2 in which the negative electrode 17 was packed. The dies as illustrated in FIGS. 6 and 7 were used to perform crimping, thereby to complete the fabrication of a coin battery (Battery X).

### Comparative Example 1

A coin battery (Battery Y) as illustrated in FIG. 10 was fabricated. The negative electrode was prepared by punching a 0.8-μm-thick metal lithium foil into a size of 16 mm in diameter. A sealing plate 22 in which the bulging portion 20 was not provided, and the diameter of the top portion was set to 17 mm was used. The battery was fabricated in the same manner as in Example 1, except the above. Here, the width of the flange portion 25 of the sealing plate 22 was set to the same as that in Example 1. The pressing of the negative electrode with a pressing die toward the top portion of the sealing plate 22 was not performed.

### Comparative Example 2

A coin battery (Battery Z) as illustrated in FIG. 11 was fabricated. The negative electrode was prepared by punching a 0.8-μm-thick metal lithium foil into a size of 17 mm in diameter. The sealing plate 22 in which the bulging portion 20 was not provided, and the diameter of the top portion was set to 18 mm was used. The battery was fabricated in almost the same manner as in Example 1, except the above. Here, the width of the flange portion 25 of the sealing plate 22 was set to a half of that in Example 1. The pressing of the negative electrode with a pressing die toward the top portion of the sealing plate 22 was not performed. The length of the side wall 28 of the battery can 21 was set such that the length of the crimp portion 29 became 0.5 mm.

Batteries X, Y and Z, 110 batteries each, were produced in the manner as described above. Batteries X, Y and Z have almost the same configuration and almost the same dimensions, except the shape of the sealing plate, the length of the crimp portion, and the negative electrode capacity. The materials of the power generation element, battery can, and sealing plate are the same among Batteries X, Y and Z.

The particulars of each battery are summarized in Table 1. The (A−B)/2 of Batteries Y and Z having no bulging portion is denoted as “0”. Dimension C is a length of the crimp portion.

### Evaluation

### (a) Initial Battery Capacity

Using 10 batteries (n=10), a 6.8-kΩ constant-resistance discharge was carried out, to check an initial battery capacity.

### (b) Number of Leaked Batteries

Using 100 batteries (n=100), a 85° C. 1 hour/−20° C. 1 hour thermal impact test was carried out under humidity 90% RH for 100 cycles in total, to check whether leakage occurred or not between the gasket and the battery can or sealing plate.

### (c) Battery Capacity After Thermal Impact Test

After the thermal impact test, the batteries in which no leakage occurred were subjected to a 6.8-kΩ constant-resistance discharge, to measure the battery capacity as an average of 100 batteries each for Batteries A and B, and an average of 89 batteries for Batteries C. The results are shown in Table 1.

TABLE 1

| | Battery X | Battery Y | Battery Z |
|---|---|---|---|
| Bulging portion | With | Without | Without |
| (A-B)/2 | 0.5 mm | 0 mm | 0 mm |
| C | 1.0 mm | 1.0 mm | 0.5 mm |
| Initial battery capacity | 335 mAh | 310 mAh | 340 mAh |
| Number of leaked batteries | 0/100 | 0/100 | 11/100 |
| (batteries/100) | | | |
| Battery capacity after thermal | 330 mAh | 305 mAh | 285 mAh |
| impact test | | | |

When exposed to high temperatures and lower temperatures repetitively, the battery expands and contracts repetitively. It is considered that during repetitive expansion and contraction, clearance occurs between the shoulder portion of the gasket and the crimp portion or the flange portion and between the base portion of the gasket and the bottom portion of the battery can or the extending portion of the sealing plate. Therefore, if the length C of the crimp portion is short, and the compressed area of the shoulder portion of the gasket is small, leakage is likely to occur.

In Batteries X and Y, in which the length C of the crimp portion was sufficiently long, and the compressed area of the shoulder portion of the gasket was large, no leakage occurred. On the other hand, in Battery Z, the length C of the crimp portion was short, and the area of the shoulder portion of the gasket was small, which reduced the sealing strength. Presumably because of this, leakage occurred.

Regarding Battery Y, the initial battery capacity thereof was the smallest. This indicates that a higher capacity is difficult to achieve with Battery Y. The larger the packing amount of the power generation element (positive electrode, negative electrode, and electrolyte) is, the higher the battery capacity is. In order to increase the packing amount of the power generation element, the battery internal volume defined by the battery can and the sealing plate should be increased. Regarding Battery Z, although the initial battery capacity thereof was the largest, the ratio of the leaked batteries after thermal impact test was high, and the battery capacity after thermal impact test was lower than that of Battery X. This is presumably because the battery characteristics were significantly deteriorated by dissipation of electrolyte, entry of moisture from outside, and other causes.

Similar effects can be obtained with batteries other than the above Example batteries, such as a battery as illustrated in FIG. 9 in which the bulging portion 20A is slanted upward from the innermost end of the flange portion 5.

### INDUSTRIAL APPLICABILITY

The coin battery of the present invention has a high capacity and is highly resistant to leakage even under such severe operating conditions that the battery is repetitively exposed to high temperatures and low temperatures, and therefore, is applicable as a power source for devices used in various environments.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: Battery can, 2: Sealing plate, 3: Gasket, 4: Constricted portion, 5: Flange portion, 6: Extending portion, 7: Bottom portion, 8: Rising portion, 9: Crimp portion, 10: Base portion, 11: Side portion, 12: Shoulder portion, 13: Top portion, 15: Positive electrode, 16: Separator, 17: Negative electrode, 19: Extreme end of crimp portion, 20: Bulging portion, 31: Lower die, 32: Upper die, 33A and 33B: Sealing die, 34: R portion, 54: Die for pressing negative electrode

1. A coin battery comprising:
a cylindrical battery can having a bottom portion, and a first side wall rising from a periphery of the bottom portion;
a sealing plate having a top portion, and a second side wall extending from a periphery of the top portion along an inner side of the first side wall;
a gasket interposed and compressed between the first side wall and the second side wall; and
a power generation element sealed with the battery can and the sealing plate, wherein
the second side wall has a bulging portion bulging outward, and a part of the power generation element is disposed inside the bulging portion.

2. The coin battery according to claim 1, wherein:
the power generation element comprises a positive electrode, a negative electrode that includes lithium metal or lithium alloy and faces the positive electrode with a separator interposed between the positive electrode and the negative electrode, and a non-aqueous electrolyte; and
the negative electrode is in contact with an inner side of the bulging portion.

3. The coin battery according to claim 1, wherein:
the second side wall has a constricted portion continuing from the bulging portion, a flange portion extending outward from the constricted portion, and an extending portion extending from the flange portion so as to face the first side wall; and
an end portion of the first side wall is crimped onto the flange portion.

4. The coin battery according to claim 3, wherein a maximum outer diameter A of the bulging portion, a minimum outer diameter B of the constricted portion, and an outer diameter D of the battery satisfy
0<(A−B)/2, and 0.7 mm<(D−A)/2.
